(19) United States
(12) Patent Application Publication
(10) Pub. No.: US 2024/0332860 A1
(43) Pub. Date: Oct. 3, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takanori OSAWA, Osaka (JP); Keigo TAKAHASHI, Osaka (JP)

(21) Appl. No.: 18/610,755

(22) Filed: Mar. 20, 2024

(30) Foreign Application Priority Data
Mar. 30, 2023 (JP) 2023-055913

(51) Int. Cl. H01R 13/58

(52) U.S. Cl. CPC H01R 13/582

(57) ABSTRACT

A connector A is provided with a terminal module 30 including a communication cable 37 having a pair of signal wires 39 embedded in an insulating sheath 38, tip regions of the pair of signal wires 39 extending as wire exposed portions 39E from a tip surface 38S of the sheath 38, and a dielectric 31 for accommodating a pair of signal terminal fittings 35 individually fixed to a pair of the wire exposed portions 39E, the wire exposed portions 39E being drawn out from signal wire draw-out openings 33 of the dielectric 31, and a housing 10 for accommodating a tip region of the communication cable 37 and the dielectric 31. The housing 10 is formed with a stopper 25 for restricting the tip surface 38T of the sheath 38 from approaching the signal wire draw-out openings 33.

### CROSS-REFERENCE TO RELATED APPLICATIONS

This application is based on and claims priority from Japanese Patent Application No. 2023-055913, filed on Mar. 30, 2023, with the Japan Patent Office, the disclosure of which is incorporated herein in its entirety by reference.

### TECHNICAL FIELD

The present disclosure relates to a connector.

### BACKGROUND

In differential signal transmission, a twisted pair cable formed by twisting two wires is used as a communication line. Japanese Patent Laid-open Publication No. 2016-162588 discloses a connector provided with a twisted pair cable, terminal portions connected to end parts of a pair of wires constituting the twisted pair cable and a connector body for accommodating a pair of the terminal portions. In an end part of the twisted pair cable, the wires are untwisted to crimp the terminal portions. The terminal portions are inserted into the connector body from behind. At this time, there is a concern that the terminal portions are improperly inserted with an operation method of simultaneously inserting the pair of terminal portions. Thus, after one terminal portion is inserted into the connector body, the other terminal portion is preferably inserted into the connector body after being temporarily moved rearward of the connector body.

### SUMMARY

To separately insert the pair of terminal portions, the wires need to be untwisted over a length corresponding at least to the entire lengths of the terminal portions. However, if the wires are untwisted, an interval between the wires is easily widened. If the interval of the wires is widened, transmission characteristics are degraded.

A connector of the present disclosure was completed on the basis of the above situation and aims to suppress the degradation of transmission characteristics.

The present disclosure is directed to a connector with a terminal module including a communication cable having a pair of signal wires embedded in an insulating sheath, tip regions of the pair of signal wires extending as wire exposed portions from a tip surface of the sheath, and a terminal holding member for accommodating a pair of terminal fittings individually fixed to a pair of the wire exposed portions, the wire exposed portions being drawn out from wire draw-out openings of the terminal holding member, and a housing for accommodating a tip region of the communication cable and the terminal holding member accommodating the pair of terminal fittings, the housing being formed with a stopper for restricting the tip surface of the sheath from approaching the wire draw-out openings.

According to the present disclosure, the degradation of transmission characteristics can be suppressed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector of a first embodiment.

FIG. 2 is an exploded perspective view of the connector shown in FIG. 1.

FIG. 3 is a perspective view showing a state where a terminal module, a one-piece rubber plug and a rubber plug holding member are mounted in a housing body in the connector of the first embodiment.

FIG. 4 is a back view of the housing body shown in FIG. 1.

FIG. 5 is a back view in section showing a state where a communication cable is routed in a routing space in the connector of the first embodiment.

FIG. 6 is a side view in section showing the state where the communication cable is routed in the routing space in the connector of the first embodiment.

FIG. 7 is a plan view in section of the connector shown in FIG. 1.

FIG. 8 is a perspective view of a connector of a second embodiment.

FIG. 9 is an exploded perspective view of the connector shown in FIG. 8.

FIG. 10 is a perspective view showing a state where a terminal module, a one-piece rubber plug and a rubber plug holding member are mounted in a housing body in the connector of the second embodiment.

FIG. 11 is a back view of the housing body shown in FIG. 8.

FIG. 12 is a plan view in section of the connector shown in FIG. 8.

FIG. 13 is a side view in section of the connector shown in FIG. 8.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described. Arbitrary combinations of a plurality of embodiments described below without contradicting each other are also included in embodiments of the invention.

(1) The connector of the present disclosure is provided with a terminal module including a communication cable having a pair of signal wires embedded in an insulating sheath, tip regions of the pair of signal wires extending as wire exposed portions from a tip surface of the sheath, and a terminal holding member for accommodating a pair of terminal fittings individually fixed to a pair of the wire exposed portions, the wire exposed portions being drawn out from wire draw-out openings of the terminal holding member, and a housing for accommodating a tip region of the communication cable and the terminal holding member accommodating the pair of terminal fittings, the housing being formed with a stopper for restricting the tip surface of the sheath from approaching the wire draw-out openings. According to the configuration of the present disclosure, since the tip surface of the sheath is prevented from approaching the wire draw-out openings of the terminal holding member by providing the stopper, the pair of signal wires can be suppressed from being buckled to separate between the wire draw-out openings and the tip surface of the sheath. That is, it can be suppressed that the pair of signal wires are buckled to separate in the wire exposed portions because a distance between the wire draw-out openings and the tip surface of the sheath is shorter than a length of parts of the pair of signal wires from the wire draw-out openings to the tip surface of the sheath. Therefore, according to the present disclosure, the degradation of transmission characteristics due to the separation of the pair of signal wires can be suppressed. Further, a length of a part of the communication cable to be routed outside the housing can be controlled.

(2) Preferably, the tip surface of the sheath butts against the stopper. According to this configuration, the shape of the housing can be simplified as compared to a structure for restricting a movement by sandwiching the sheath.

(3) Preferably in (2), the housing is formed with a routing groove, the wire exposed portions being routed in the routing groove, and an accommodation recess wider than the routing groove, a tip part of the sheath being accommodated into the accommodation recess, and a step portion formed on a boundary between the routing groove and the accommodation recess functions as the stopper. According to this configuration, the shape of the housing can be simplified as compared to the case where a dedicated independently shaped stopper is formed separately from the step portion.

(4) Preferably in (3), the housing is provided with a housing body having a box shape including an opening in a rear surface, the housing body including a module accommodation chamber, the routing groove and the accommodation recess, the terminal holding member being inserted into the module accommodation chamber from behind, and a cover to be assembled with the housing body to close the opening, the accommodation recess is shaped to be open rearward, and the cover is formed with a separation restricting portion for restricting the tip surface of the sheath from being displaced rearward and disengaged from the stopper when the tip surface of the sheath is restricted from moving by the stopper. According to this configuration, the tip part of the sheath can be prevented from being displaced rearward and disengaged from the stopper.

(5) Preferably in (4), a width of the routing groove is smaller than an outer diameter of the sheath, and a part of the separation restricting portion is arranged to overlap the routing groove in a back view of the housing. According to this configuration, if the tip surface of the sheath is located closer to the routing groove than the stopper when the communication cable is accommodated into the housing body from behind, the sheath is located behind a position facing the stopper, i.e. a position where the movement is restricted by the stopper. In this case, since the separation restricting portion interferes with the tip part of the sheath when the cover is assembled with the housing body, the cover is hindered from being assembled at a proper position with respect to the housing body. Therefore, whether or not the sheath is arranged at a proper position can be detected based on whether or not the cover can be assembled with the housing body.

(6) Preferably in (4) or (5), another terminal fitting fixed to a wire different from the signal wires is accommodated in the terminal holding member, and the separation restricting portion is arranged to divide routing paths for the signal wires and a routing path for the other wire in the housing body. According to this configuration, the housing body needs not be formed with a dedicated partition wall portion for dividing a routing space for the signal wires and a routing space for the other wire. In this way, the shape of the housing body can be simplified.

### Details of Embodiments of Present Disclosure

### First Embodiment

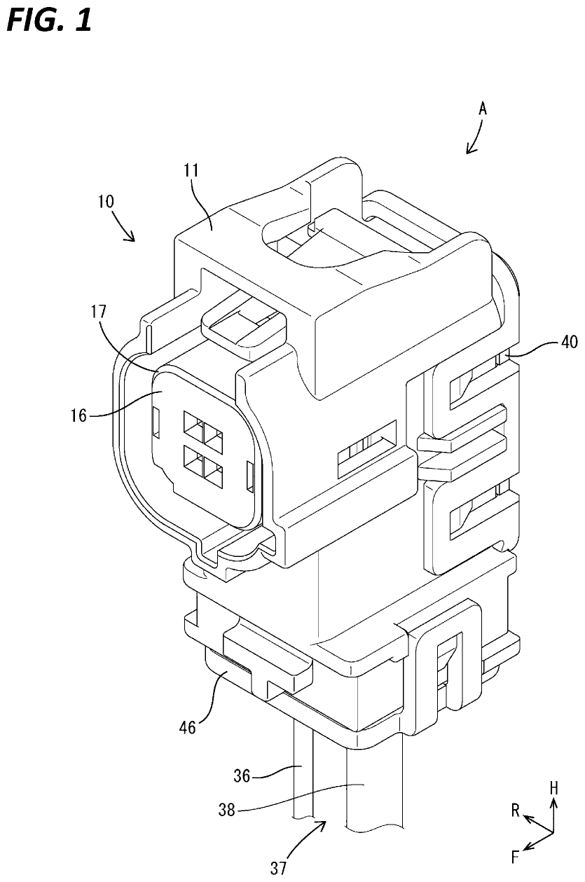

A connector A of a first specific embodiment of the present disclosure is described with reference to FIGS. 1 to 7. The present invention is not limited to these illustrations, but is represented by claims and intended to include all changes in the scope of claims and in the meaning and scope of equivalents. In the first embodiment, a direction F in FIGS. 1 to 3, 6 and 7 is defined as a forward direction concerning a front-rear direction. A direction H in FIGS. 1 to 6 is defined as an upward direction concerning a vertical direction. A direction R in FIGS. 1 to 5 and 7 is defined as a rightward direction concerning a lateral direction. The lateral direction and a width direction are used as synonyms.

The connector A of the first embodiment is provided with a housing 10 and a terminal module 30. In a side view of the connector A, the connector A has a vertically long block shape as a whole.

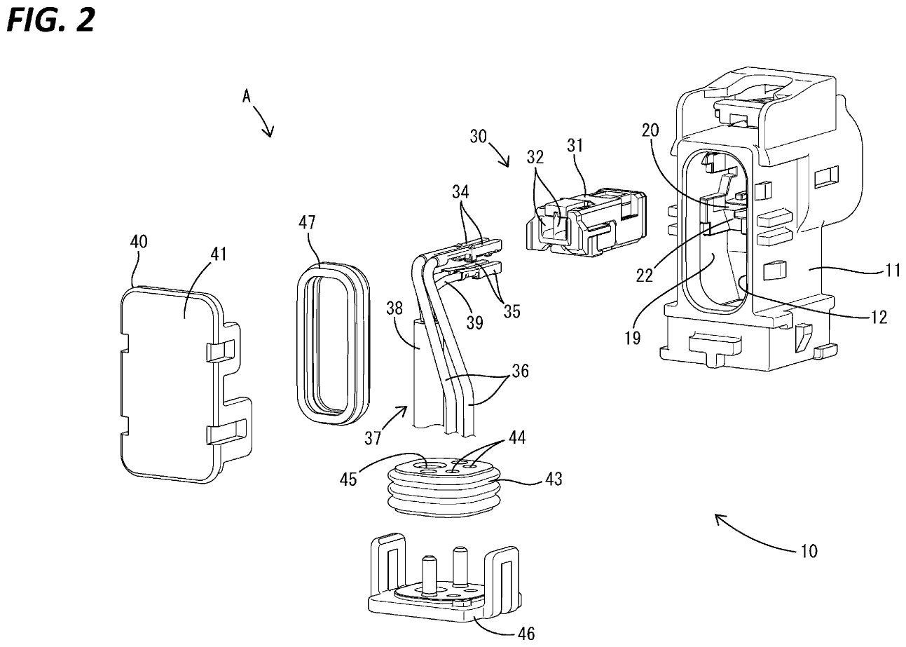

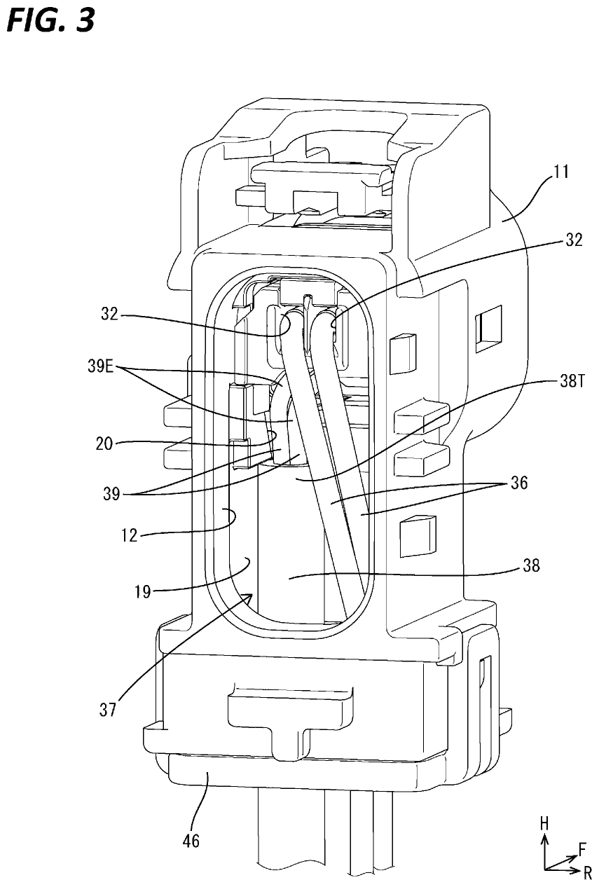

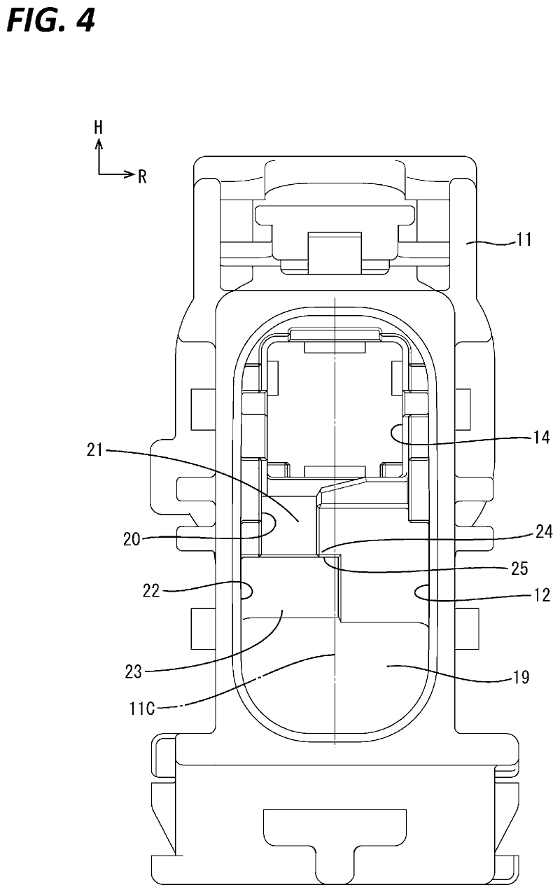

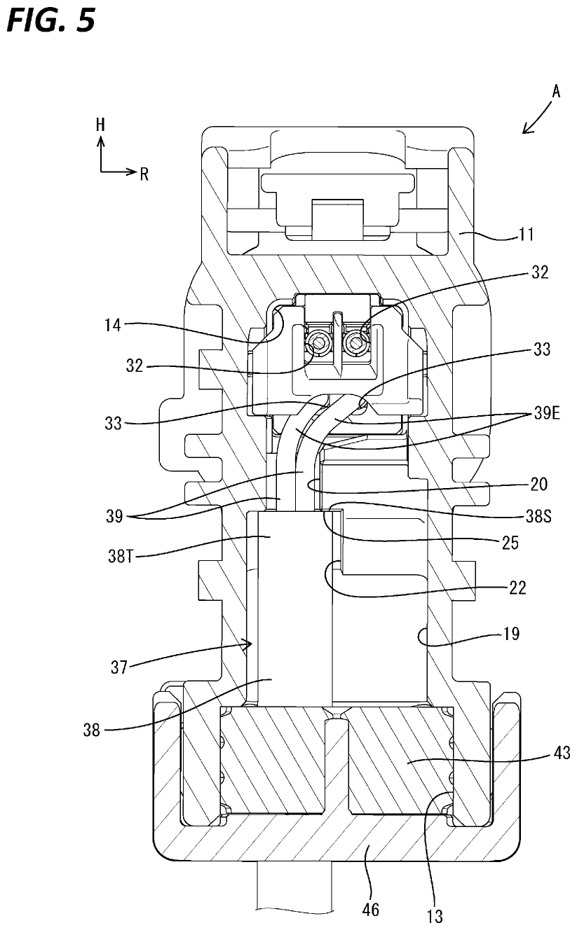

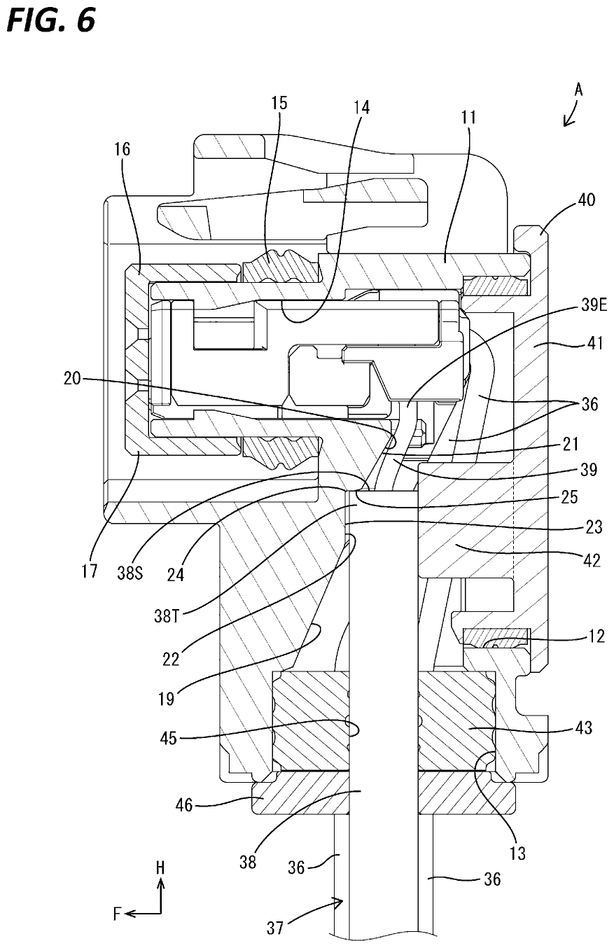

The housing 10 is configured by assembling a housing body 11, a cover 40, a one-piece rubber plug 43, a rubber plug holding member 46 and a rear sealing member 47. As shown in FIGS. 2 and 3, the housing body 11 is a box-shaped member including an opening 12 in a rear surface. As shown in FIGS. 5 and 6, a lower wall part of the housing body 11 is formed with a routing hole 13 vertically penetrating through the lower wall part. As shown in FIGS. 4 to 6, an upper end part of the housing body 11 is formed with a module accommodation chamber 14. The front end of the module accommodation chamber 14 is open in the front surface of the housing body 11. The rear end of the module accommodation chamber 14 is open rearward in the housing body 11. A fitting portion 17 to be fit to a mating connector (not shown) is formed by mounting a front sealing member 15 and a front member 16 on an upper end part of the front surface of the housing body 11.

A routing space 19 communicating with the rear end of the module accommodation chamber 14 is formed inside the housing body 11. The routing space 19 is composed of a region behind the module accommodation chamber 14 and a region below the module accommodation chamber 14, out of the housing body 11. A pair of power wires 36 and one communication cable 37 are routed in the vertical direction in the routing space 19. A routing groove 20 and an accommodation recess 22 are formed in an upper end part of the routing space 19.

The routing groove 20 is a groove portion open both upward and downward and rearward. As shown in FIGS. 4 and 5, in a back view of the housing body 11, the upper end of the routing groove 20 is located slightly below the module accommodation chamber 14. The routing groove 20 is arranged at a position deviated leftward in the width direction from a widthwise center 11C of the housing body 11. As shown in FIG.

6, a groove bottom surface 21 of the routing groove 20 is inclined in an overhanging manner such that a lower end is located forward of an upper end.

The accommodation recess 22 is a recess open downward and rearward. As shown in FIGS. 4 and 5, the accommodation recess 22 is arranged at a position deviated leftward in the width direction from the widthwise center 11C of the housing body 11, similarly to the routing groove 20. The routing groove 20 and the accommodation recess 22 are arranged adjacent in the vertical direction. The upper end of the accommodation recess 22 communicates with the lower end of the routing groove 20. In the back view, a width of the accommodation recess 22 is larger than that of the routing groove 20. As shown in FIG. 6, a back surface 23 (front surface) of the accommodation recess 22 is located forward of the groove bottom surface 21 of the routing groove 20. A boundary between a lower end part of the accommodation recess 22 and that of the routing groove 20 constitutes a step portion 24. A part of the step portion 24 facing the inside of the accommodation recess 22 functions as a stopper 25. The stopper 25 has a “U shape” open rearward when the accommodation recess 22 is viewed from below.

As shown in FIG. 2, the terminal module 30 includes a dielectric 31, a pair of signal terminal fittings 35, a pair of power supply terminal fittings 34, the pair of power wires 36 and one communication cable 37. The dielectric 31 is, for example, configured by assembling a plurality of components. The pair of power supply terminal fittings 34 and the pair of signal terminal fittings 35 are accommodated in the dielectric 31. A pair of power supply wire draw-out openings 32 arranged at an interval in the width direction and a pair of signal wire draw-out openings 33 arranged at an interval in the width direction are formed in the rear surface of the dielectric 31. The pair of power supply wire draw-out openings 32 are open in an upper region of the rear surface of the dielectric 31. The pair of signal wire draw-out openings 33 are open in a lower region of the rear surface of the dielectric 31. The terminal module 30 is inserted into the module accommodation chamber 14 from behind the housing body 11.

The pair of power wires 36 are constituted by coated wires. The power supply terminal fitting 34 is fixed to a tip part of each power wire 36. The power wire 36 is drawn out rearward from the power supply wire draw-out opening 32 of the dielectric 31. The pair of power wires 36 drawn out from the power supply wire draw-out openings 32 are routed in the vertical direction in a right half region of the routing space 19.

The communication cable 37 is an electrically conductive path for differential communication and includes a sheath 38 having a circular cross-section and a pair of signal wires 39 embedded in the sheath 38. The signal wire 39 is constituted by a coated wire. In the sheath 38, the pair of signal wires 39 are twisted to form a twisted pair cable (not shown). In a tip part of the communication cable 37, the sheath 38 is removed to expose tip parts of the pair of signal wires 39. A part of the signal wire 39 projecting from a tip surface 38S of the sheath 38 and untwisted is defined as a wire exposed portion 39E. The signal terminal fitting 35 is fixed to a tip part of each wire exposed portion 39E. The wire exposed portion 39E is drawn out rearward from the signal wire draw-out opening 33 of the dielectric 31.

The communication cable 37 is routed in the vertical direction in a left half region of the routing space 19. A tip part 38T of the sheath 38 is accommodated in the accommodation recess 22 with the tip surface 38S facing upward. The tip surface 38S of the sheath 38 is located to come into contact with or closely face the stopper 25 from below. A pair of the wire exposed portions 39E (signal wires 39) drawn out from the signal wire draw-out openings 33 are accommodated in the routing groove 20. The pair of wire exposed portions 39E are arranged laterally side by side in parallel and proximity to each other with axes oriented in the vertical direction. Parts of the pair of wire exposed portions 39E between the signal wire draw-out openings 33 and the upper end of the routing groove 20 are routed in a direction oblique to the both vertical direction and width direction in a back view.

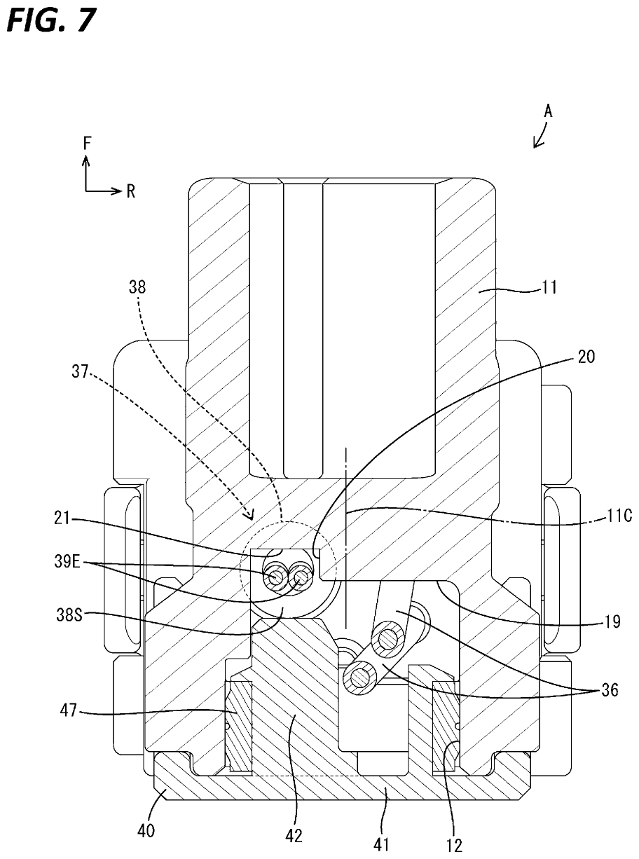

The cover 40 is mounted on the housing body 11 to close the opening 12. As shown in FIGS. 6 and 7, the cover 40 includes a plate-like body portion 41 for closing the opening 12 and a separation restricting portion 42 projecting from the front surface of the plate-like body portion 41. With the cover 40 mounted on the housing body 11, the separation restricting portion 42 is arranged in the routing space 19. As shown in FIG. 7, the separation restricting portion 42 is arranged at a position shifted leftward from a widthwise center of the cover 40. As shown in FIG. 6, the separation restricting portion 42 is located to cover a lower end side region of the routing groove 20, the accommodation recess 22 and a region below the accommodation recess 22 from behind.

The one-piece rubber plug 43 is mounted into the routing hole 13 of the housing body 11 in a liquid-tight manner. As shown in FIG. 2, the one-piece rubber plug 43 is formed with a pair of first sealing holes 44 and one second sealing hole 45 penetrating through the one-piece rubber plug 43 in the vertical direction. The pair of power wires 36 are inserted through the pair of first sealing holes 44 in a liquid-tight manner. The communication cable 37 is inserted through the second sealing hole 45 in a liquid-tight manner. The rubber plug holding member 46 is mounted on a lower end part of the housing body 11. The rubber plug holding member 46 is a member for preventing the one-piece rubber plug 43 from coming out downward from the routing hole 13.

Next, an assembly procedure of the connector A is described. With the sheath 38 of the communication cable 37 and the power wires 36 inserted through the one-piece rubber plug 43, the signal terminal fittings 35 are crimped to the signal wires 39 and the power supply terminal fittings 34 are fixed to the power wires 36. Subsequently, the signal terminal fittings 35 and the power supply terminal fittings 34 are accommodated into the dielectric 31, thereby assembling the terminal module 30. Thereafter, the assembled terminal module 30 is passed through the routing hole 13 from below the housing body 11, passed through the routing space 19 and temporarily pulled out rearward to the outside of the housing body 11 through the opening 12. Thereafter, the dielectric 31 is inserted into the module accommodation chamber 14 from behind.

Thereafter, the two power wires 36 are accommodated into the right region in the routing space 19 and routed in the vertical direction. The communication cable 37 is accommodated into the left region in the routing space 19 and routed in the vertical direction. In routing the communication cable 37, the tip part 38T of the sheath 38 of the communication cable 37 is accommodated into the accommodation recess 22 and the two wire exposed portions 39E are accommodated into the routing groove 20. Further, parts of the wire exposed portions 39E above the routing groove 20 are routed obliquely to the both vertical direction and width direction between the upper end of the routing groove 20 and the signal wire draw-out openings 33. The two wire exposed portions 39E are routed between the tip surface 38S of the sheath 38 and the signal wire draw-out openings 33 while hardly having an extra length. Therefore, the two wire exposed portions 39E are not largely separated in the width direction also between the routing groove 20 and the signal wire draw-out openings 33.

After the power wires 36 and the communication cable 37 are routed in the routing space 19, the one-piece rubber plug 43 is moved upward and mounted into the routing hole 13 with the power wires 36 and the communication cable 37 held not to move upward with respect to the housing body 11. Thereafter, the rubber plug holding member 46 is mounted on the lower end part of the housing body 11.

Thereafter, the cover 40 having the rear sealing member 47 mounted therein is mounted on a rear surface part of the housing body 11. In this way, the opening 12 in the rear surface of the housing body 11 is closed in a liquid-tight manner by the plate-like body portion 41 of the cover 40 and the rear sealing member 47. In the above way, the assembly of the connector A is completed.

There is a concern that the communication cable 37 is pushed upward when the one-piece rubber plug 43 is moved upward. If the tip part 38T of the sheath 38 moves further upward than the stopper 25, the wire exposed portions 39E are deformed to be buckled between the tip surface 38S of the sheath 38 and the signal wire draw-out openings 33, with the result that the two wire exposed portions 39E may be separated to degrade transmission characteristics. However, in the first embodiment, the communication cable 37 (tip part 38T of the sheath 38) is prevented from moving upward in the routing space 19 by the tip surface 38S of the sheath 38 butting against the stopper 25 from below. Therefore, the degradation of transmission characteristics due to the separation of the pair of wire exposed portions 39E can be prevented.

With the cover 40 mounted on the housing body 11, the separation restricting portion 42 formed in the cover 40 enters the routing space 19 and comes into contact with or closely faces the tip part 38T of the sheath 38 from behind. Since a rearward movement of the communication cable 37 is restricted in this way, the sheath 38 is held accommodated in the accommodation recess 22 and the wire exposed portions 39E are held accommodated in the routing groove 20.

Further, since a width of the routing groove 20 is set to be smaller than an outer diameter of the tip part 38T of the sheath 38, the sheath 38 cannot be accommodated in the routing groove 20 with the tip part 38T of the sheath 38 located above the stopper 25. In this case, the tip part 38T of the sheath 38 is located behind a position where the tip part 38T is accommodated in the accommodation recess 22, i.e. a position where the tip part 38T is facing the stopper 25. Here, in a back view, the separation restricting portion 42 is arranged to overlap not only the accommodation recess 22, but also the routing groove 20. Therefore, if the tip surface 38S of the sheath 38 is located above the stopper 25 when an attempt is made to mount the cover 40 on the housing body 11, the separation restricting portion 42 interferes with the tip part 38T of the sheath 38 during a mounting operation. Thus, the cover 40 cannot be assembled with the housing body 11. In this way, it can be detected that the tip part 38T of the sheath 38 is outside the accommodation recess 22.

As shown in FIG. 7, in a horizontal cross-section of the connector A when viewed from above, the power wires 36 are routed in a region to the right of the widthwise center 11C in the routing space 19. On the other hand, the sheath 38 of the communication cable 37 is routed in a region to the left of the widthwise center 11C in the routing space 19. The separation restricting portion 42 is located to the left of and adjacent to routing paths for the power wires 36, and located behind and adjacent to a routing path for the tip part (wire exposed portions 39E) of the communication cable 37. In this way, the routing path for the tip part of the communication cable 37 and those for the power wires 36 are separated by the separation restricting portion 42. Therefore, there is no possibility that the power wires 36 approach the communication cable 37 in the routing space 19.

The connector A of the first embodiment is provided with the terminal module 30 and the housing 10. The terminal module 30 includes the communication cable 37, the dielectric 31 and the pair of signal terminal fittings 35. The communication cable 37 is configured such that the pair of signal wires 39 are embedded in the insulating sheath 38. The sheath 38 is removed in the tip region of the communication cable 37. The tip parts of the pair of signal wires 39 extend as the wire exposed portions 39E from the tip surface 38S of the sheath 38. The pair of wire exposed portions 39E are individually fixed to the pair of signal terminal fittings 35. The pair of signal terminal fittings 35 are accommodated in the dielectric 31. The pair of wire exposed portions 39E are individually drawn out rearward from the pair of signal wire draw-out openings 33 open in the rear surface of the dielectric 31. The dielectric 31 accommodating the tip part of the communication cable 37 and the pair of signal terminal fittings 35 is accommodated in the housing 10.

The housing 10 is formed with the stopper 25 for restricting the approach of the tip surface 38S of the sheath 38 to the signal wire draw-out openings 33. By providing the stopper 25 in the housing 10, the tip surface 38S of the sheath 38 is prevented from approaching the signal wire draw-out openings 33 of the dielectric 31, wherefore the pair of wire exposed portions 39E (signal wires 39) can be suppressed from being buckled to separate between the signal wire draw-out openings 33 and the tip surface 38S of the sheath 38. That is, it can be suppressed that the pair of signal wires 39 are buckled to separate in the wire exposed portions 39E because a distance between the signal wire draw-out openings 33 and the tip surface 38S of the sheath 38 is shorter than a length of parts of the pair of signal wires 39 from the signal wire draw-out openings 33 to the tip surface 38S of the sheath 38. Therefore, according to the connector A of the first embodiment, the degradation of transmission characteristics due to the separation of the pair of signal wires 39 in the wire exposed portions 39E can be suppressed.

The tip surface 38S of the sheath 38 preferably butts against the stopper 25. According to this configuration, the shape of the stopper 25 can be simplified as compared to a structure for restricting a movement by the stopper 25 sandwiching the sheath 38. Further, by setting the tip surface 38S of the sheath 38 in a state in contact with the stopper 25 or closely facing the stopper 25, the tip part 38T of the sheath 38 is positioned with respect to the housing 10 in a length direction of the communication cable 37. In this way, a length of a part of the communication cable 37 to be routed outside the housing 10 can be controlled.

The housing 10 is formed with the routing groove 20, in which the wire exposed portions 39E are routed, and the accommodation recess 22 wider than the routing groove 20 and configured to accommodate the tip part 38T of the sheath 38. The step portion 24 formed on the boundary between the routing groove 20 and the accommodation recess 22 functions as the stopper 25. According to this configuration, the shape of the housing 10 can be simplified in the connector A of the first embodiment as compared to the case where a dedicated independently shaped stopper 25 is formed separately from the step portion 24.

The housing 10 is provided with the housing body 11 and the cover 40. The housing body 11 has a box shape including the opening 12 in the rear surface. The housing body 11 includes the module accommodation chamber 14, into which the dielectric 31 is inserted from behind, the routing groove 20 and the accommodation recess 22. The accommodation recess 22 is shaped to be open rearward. The cover 40 is assembled with the housing body 11 to close the opening 12. The cover 40 is formed with the separation restricting portion 42 for restricting the tip surface 38S of the sheath 38 from being displaced rearward and disengaged from the stopper 25 when a movement of the tip surface 38S of the sheath 38 is restricted by the stopper 25. According to this configuration, the tip surface 38S of the sheath 38 can be prevented from being displaced rearward and disengaged from the stopper 25.

The width of the routing groove 20 is smaller than the outer diameter of the sheath 38. In the back view of the housing 10, a part of the separation restricting portion 42 is arranged to overlap the routing groove 20. According to this configuration, if the tip surface 38S of the sheath 38 is located closer to the routing groove 20 than the stopper 25 when the communication cable 37 is accommodated into the housing body 11 from behind, the sheath 38 is located behind the position facing the stopper 25, i.e. the position where a movement is restricted by the stopper 25. In this case, since the separation restricting portion 42 interferes with the tip part 38T of the sheath 38 when the cover 40 is assembled with the housing body 11, the cover 40 is hindered from being assembled at a proper position with respect to the housing body 11. Therefore, according to the connector A of the first embodiment, whether or not the sheath 38 is arranged at a proper position can be detected based on whether or not the cover 40 can be assembled with the housing body 11.

The power supply terminal fittings 34 fixed to the power wires 36 different from the signal wires 39 are accommodated in the dielectric 31. The separation restricting portion 42 is arranged to divide the routing paths for the signal wires 39 (wire exposed portions 39E) and the routing paths for the power wires 36 in the housing body 11. According to this configuration, the housing body 11 needs not be formed with a dedicated partition wall portion for dividing the routing space 19 for the wire exposed portions 39E and the routing space 19 for the power wires 36. In this way, the shape of the housing body 11 can be simplified.

### Second Embodiment

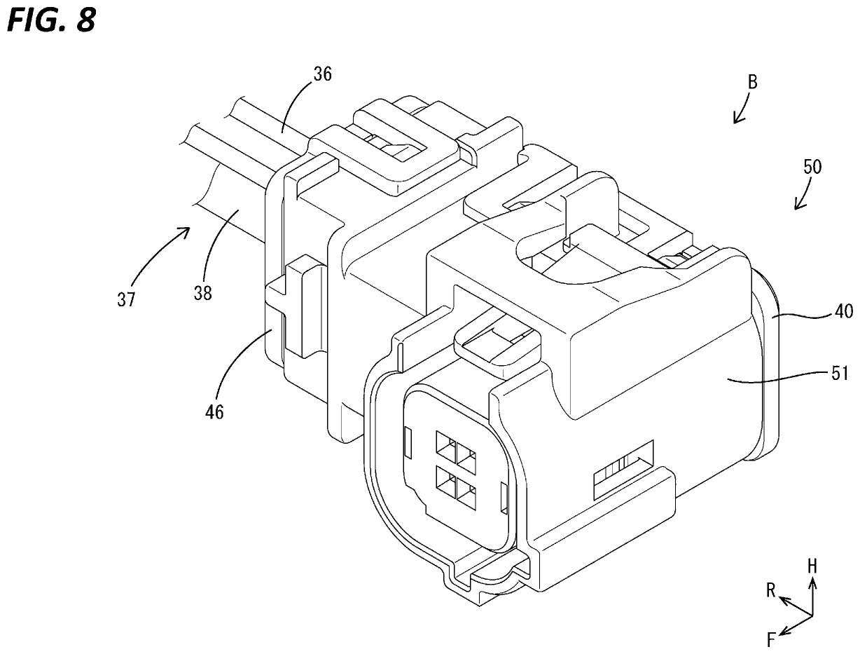

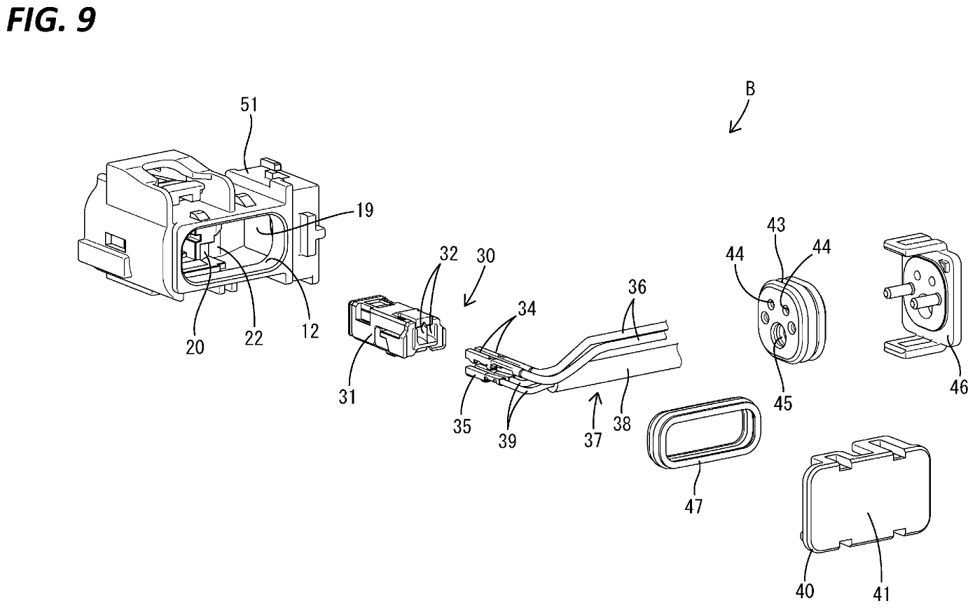

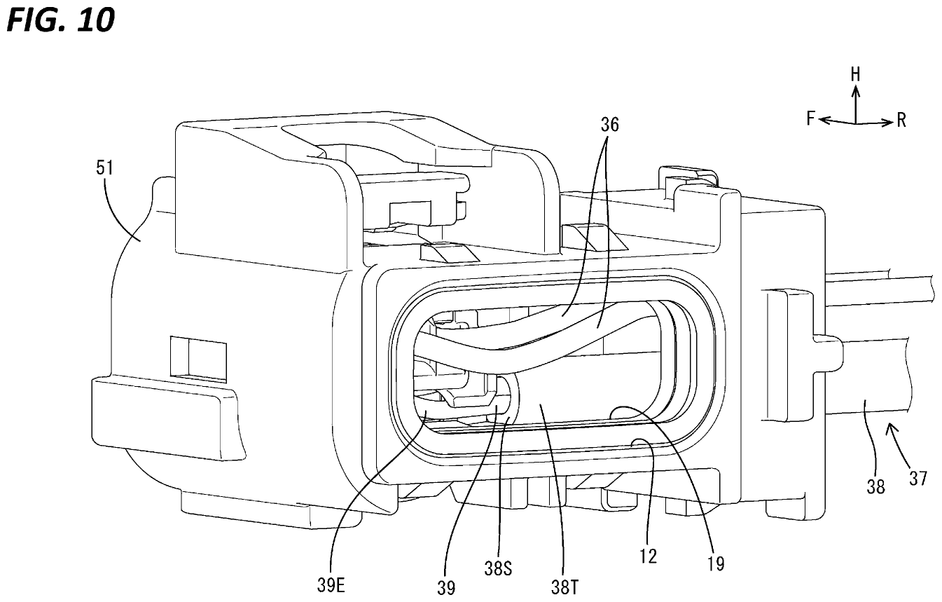

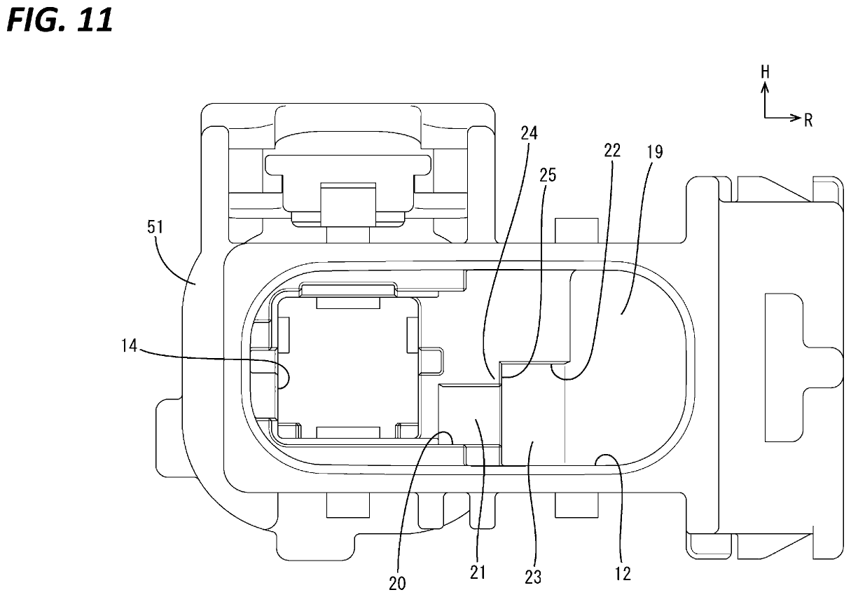

A connector B of a second specific embodiment of the present disclosure is described with reference to FIGS. 8 to 13. In the second embodiment, a direction F in FIGS. 8 to 10, 12 and 13 is defined as a forward direction concerning a front-rear direction. A direction H in FIGS. 8 to 11 and 13 is defined as an upward direction concerning a vertical direction. A direction R in FIGS. 8 to 12 is defined as a rightward direction concerning a lateral direction. The connector B of the second embodiment differs from the first embodiment in the configuration of a housing 50. Since the other components are the same as in the first embodiment, the same components are denoted by the same reference signs and the structures, functions and effects thereof are not described.

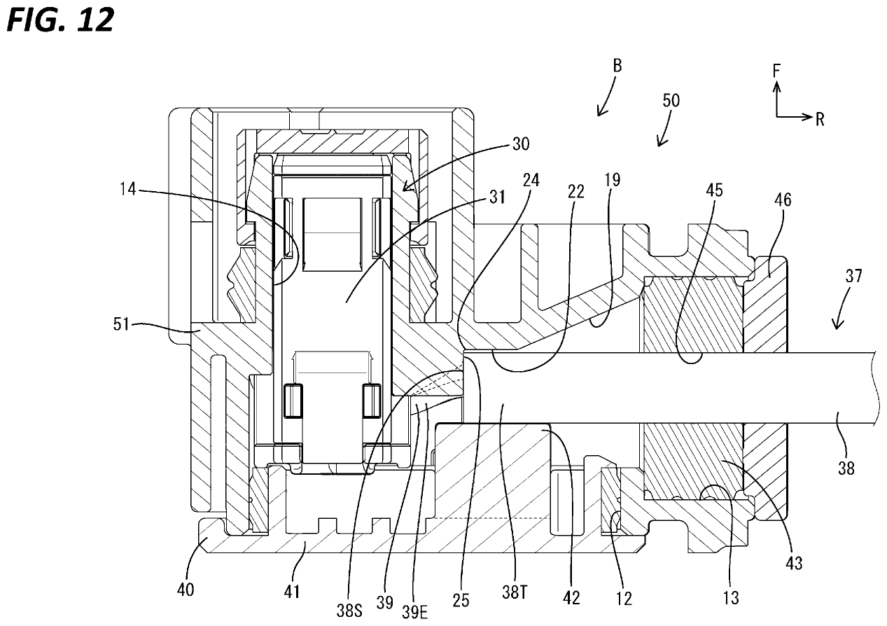

As shown in FIG. 12, a housing body 51 constituting the housing 50 of the second embodiment includes an opening 12 open in the rear surface of the housing body 51, a module accommodation chamber 14, a routing space 19 and a routing hole 13. The module accommodation chamber 14 is arranged in a left end part of the housing body 51. A terminal module 30 is inserted into the module accommodation chamber 14 from behind. The routing hole 13 is arranged in a right end part of the housing body 51. Out of the housing body 51, a space from behind the module accommodation chamber 14 to the routing hole 13 functions as the routing space 19. One communication cable 37 and a pair of power wires 36 are routed in the lateral direction in the routing space 19. In the second embodiment, the vertical direction (height direction) orthogonal to a routing direction of the communication cable 37 and the power wires 36 in a back view (not shown) of the housing body 51 is defined as a width direction.

With the terminal module 30 accommodated in the module accommodation chamber 14, a pair of power supply wire draw-out openings 32 are arranged side by side in the lateral direction in a region above a widthwise center 51C (center in the height direction) of the housing body 51 in the width direction in the rear surface of a dielectric 31. A pair of signal wire draw-out openings 33 are arranged side by side in the lateral direction in a region below the widthwise center height 51C in the width direction in the rear surface of the dielectric 31. The pair of power wires 36 are routed in a region shifted upward in the width direction from the widthwise center 51C, out of the routing space 19. The communication cable 37 is routed in a region shifted downward in the width direction from the widthwise center 51C, out of the routing space 19.

A tip part 38T of a sheath 38 is accommodated into an accommodation recess 22 and positioned in the vertical direction with a tip surface 38S facing leftward. The width direction is a direction orthogonal to an axis of the tip part 38T of the sheath 38 in the accommodation recess 22 in the back view. A routing groove 20, the accommodation recess 22 and the communication cable 37 are arranged at positions deviated downward in the width direction from the widthwise center 51C. A step portion 24 is formed on a boundary between the left end of the accommodation recess 22 and the right end of the routing groove 20. The step portion 24 is formed with a stopper 25 for restricting the tip part 38T of the sheath 38 from being shifted leftward by being brought into contact with the tip surface 38S of the sheath 38.

An assembly procedure of the connector B is described. After the dielectric 31 of the terminal module 30 is inserted into the module accommodation chamber 14 in a procedure similar to that of the first embodiment, the two power wires 36 are routed in an upper region in the routing space 19 and the communication cable 37 is routed in a lower region in the routing space 19. In routing the communication cable 37, the tip part 38T of the sheath 38 is accommodated into the accommodation recess 22 and two wire exposed portions 39E are accommodated into the routing groove 20.

After the power wires 36 and the communication cable 37 are routed in the routing space 19, a one-piece rubber plug 43 is moved leftward and mounted into the routing hole 13 with the power wires 36 and the communication cable 37 held not to move leftward with respect to the housing body 51. Thereafter, a rubber plug holding member 46 is mounted on a right end part of the housing body 51. There is a concern that the communication cable 37 is pushed leftward when the one-piece rubber plug 43 is moved leftward. However, since the tip surface 38S of the sheath 38 is in contact with the stopper 25 from right or closely facing the stopper 25 from right, the communication cable 37 does not move leftward in the routing space 19.

Thereafter, the cover 40 having a rear sealing member 47 mounted therein is mounted on a rear surface part of the housing body 51. In this way, the opening 12 in the rear surface of the housing body 51 is closed in a liquid-tight manner by a plate-like body portion 41 of the cover 40 and the rear sealing member 47. In the above way, the assembly of the connector B is completed.

With the cover 40 mounted on the housing body 51, a separation restricting portion 42 formed in the cover 40 enters the routing space 19 and comes into contact with or closely faces the tip part 38T of the sheath 38 from behind. Since a rearward movement of the communication cable 37 is restricted in this way, the sheath 38 is held accommodated in the accommodation recess 22 and the wire exposed portions 39E are held accommodated in the routing groove 20.

Further, in the back view, the separation restricting portion 42 is arranged to overlap not only the accommodation recess 22, but also the routing groove 20. An outer diameter of the sheath 38 is larger than a width of the routing groove 20. Therefore, if the tip part 38T of the sheath 38 is deviated leftward from the stopper 25 and located to overlap the routing groove 20 when the cover 40 is mounted on the housing body 51, the separation restricting portion 42 butts against the tip part 38T of the sheath 38, whereby the cover 40 cannot be mounted.

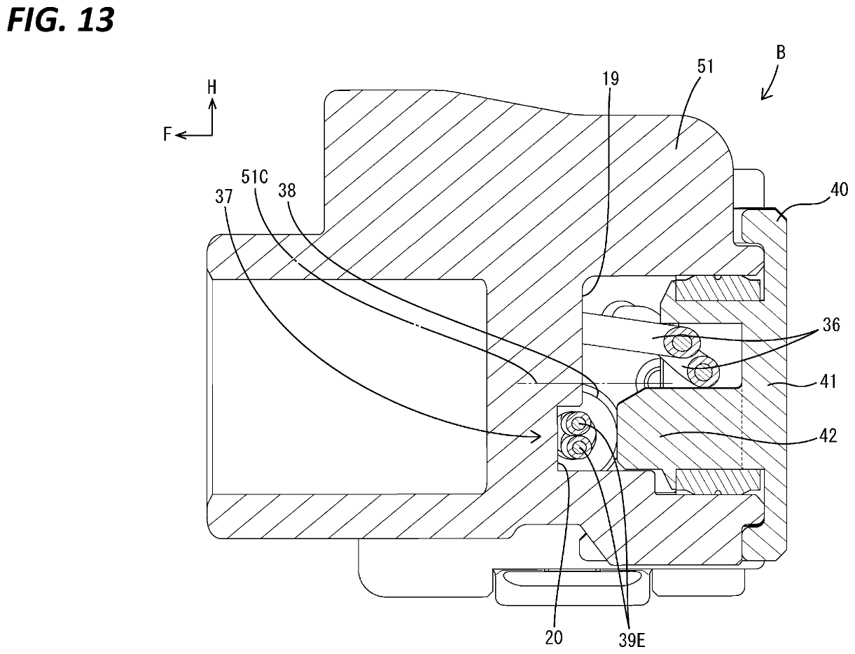

In a side cross-section of the connector B cut orthogonal to a routing direction of the power wires 36 and the communication cable 37 when viewed from left, the power wires 36 are routed in the region above the widthwise center 51C in the routing space 19 as shown in FIG. 13. On the other hand, the sheath 38 of the communication cable 37 is routed in the region below the widthwise center 51C in the routing space 19. The separation restricting portion 42 is located below and adjacent to routing paths for the power wires 36 and located behind and adjacent to a routing path for the tip part (wire exposed portions 39E) of the communication cable 37. In this way, the routing path for the tip part of the communication cable 37 and the routing paths for the power wires 36 are divided by the separation restricting portion 42. Therefore, there is no possibility that the power wires 36 approach the communication cable 37 in the routing space 19.

The housing 50 is formed with the stopper 25 for restricting the approach of the tip surface 38S of the sheath 38 to the signal wire draw-out openings 33. By providing the stopper 25, the tip surface 38S of the sheath 38 is prevented from approaching the signal wire draw-out openings 33, wherefore the pair of wire exposed portions 39E (signal wires 39) can be suppressed from being buckled to separate between the signal wire draw-out openings 33 and the tip surface 38S of the sheath 38. That is, it can be suppressed that the pair of signal wires 39 are buckled to separate in the wire exposed portions 39E because a distance between the signal wire draw-out openings 33 and the tip surface 38S of the sheath 38 is shorter than a length of parts of the pair of signal wires 39 from the signal wire draw-out openings 33 to the tip surface 38S of the sheath 38. Therefore, the degradation of transmission characteristics due to the separation of the pair of signal wires 39 in the wire exposed portions 39E can be suppressed.

Since the tip surface 38S of the sheath 38 butts against the stopper 25, the shape of the stopper 25 can be simplified as compared to a structure for restricting a movement by sandwiching the sheath 38. Further, a length of a part of the communication cable 37 to be routed outside the housing 50 can be controlled. Since the step portion 24 formed by a width difference between the routing groove 20 and the accommodation recess 22 is caused to function as the stopper 25, the shape of the housing 50 can be simplified as compared to the case where an independently shaped stopper 25 is formed.

With a movement of the tip surface 38S of the sheath 38 restricted by the stopper 25, a rearward displacement of the tip surface 38S of the sheath 38 is restricted by the separation restricting portion 42 of the cover 40. In this way, the tip surface 38S of the sheath 38 can be prevented from being disengaged rearward from the stopper 25. The separation restricting portion 42 is arranged to divide the routing paths for the signal wires 39 (wire exposed portions 39E) and the routing paths for the power wires 36 in the housing body 51. The housing body 51 needs not be formed with a dedicated partition wall portion for dividing the routing space 19 for the wire exposed portions 39E and the routing space 19 for the power wires 36. In this way, the shape of the housing body 11 can be simplified.

Since the width of the routing groove 20 is smaller than the outer diameter of the sheath 38, the sheath 38 cannot be accommodated into the routing groove 20. Thus, if the tip surface 38S of the sheath 38 is located closer to the routing groove 20 than the stopper 25 when the communication cable 37 is accommodated into the housing body 51 from behind, the sheath 38 is located behind a position facing the stopper 25. A part of the separation restricting portion 42 is arranged behind the routing groove 20. If the tip surface 38S of the sheath 38 is located closer to the routing groove 20 than the stopper 25 when the cover 40 is assembled with the housing body 51, the separation restricting portion 42 interferes with the tip part 38T of the sheath 38, wherefore the cover 40 cannot be assembled. Therefore, whether or not the sheath 38 is arranged at a proper position can be detected based on whether or not the cover 40 can be assembled with the housing body 51.

### Other Embodiments

The present invention is not limited to the above described and illustrated embodiments, but is represented by claims. The present invention is intended to include all changes in the scope of claims and in the meaning and scope of equivalents and also include the following embodiments.

The communication cable may be such that two or more pairs of signal wires are embedded in the sheath.

The stopper may restrict a movement by sandwiching the sheath.

The housing body may not include the routing groove.

The housing body may not include the accommodation recess.

The housing body may be formed with a dedicated partition wall portion for dividing the routing space for the signal wires and the routing space for other wires (power wires).

The cover may not include the separation restricting portion.

The stopper may be formed on the cover.

The separation restricting portion may not overlap the routing groove in the back view.

The cover may not include the separation restricting portion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a terminal module including a communication cable having a pair of signal wires embedded in an insulating sheath, tip regions of the pair of signal wires extending as wire exposed portions from a tip surface of the sheath, and a terminal holding member for accommodating a pair of terminal fittings individually fixed to a pair of the wire exposed portions, the wire exposed portions being drawn out from wire draw-out openings of the terminal holding member; and
a housing for accommodating a tip region of the communication cable and the terminal holding member accommodating the pair of terminal fittings,
the housing being formed with a stopper for restricting the tip surface of the sheath from approaching the wire draw-out openings.

2. The connector of claim 1, wherein the tip surface of the sheath butts against the stopper.

3. The connector of claim 2, wherein:
the housing is formed with a routing groove, the wire exposed portions being routed in the routing groove, and an accommodation recess wider than the routing groove, a tip part of the sheath being accommodated into the accommodation recess, and
a step portion formed on a boundary between the routing groove and the accommodation recess functions as the stopper.

4. The connector of claim 3, wherein:
the housing is provided with:
a housing body having a box shape including an opening in a rear surface, the housing body including a module accommodation chamber, the routing groove and the accommodation recess, the terminal holding member being inserted into the module accommodation chamber from behind; and
a cover to be assembled with the housing body to close the opening, the accommodation recess is shaped to be open rearward, and
the cover is formed with a separation restricting portion for restricting the tip surface of the sheath from being displaced rearward and disengaged from the stopper when the tip surface of the sheath is restricted from moving by the stopper.

5. The connector of claim 4, wherein:
a width of the routing groove is smaller than an outer diameter of the sheath, and
a part of the separation restricting portion is arranged to overlap the routing groove in a back view of the housing.

6. The connector of claim 4, wherein:
another terminal fitting fixed to a wire different from the signal wires is accommodated in the terminal holding member, and
the separation restricting portion is arranged to divide routing paths for the signal wires and a routing path for the other wire in the housing body.
